(19) United States
(12) Patent Application Publication
(10) Pub. No.: US 2017/0254252 A1
(43) Pub. Date: Sep. 7, 2017

(54) ENGINE HAVING WATER JACKET

(71) Applicants: Hyundai Motor Company, Seoul (KR); Kia Motors Corporation, Seoul (KR)

(72) Inventor: Yong Woo KIM, Seongnam-si (KR)

(73) Assignees: Hyundai Motor Company, Seoul (KR); Kia Motors Corporation, Seoul (KR)

(21) Appl. No.: 15/270,944

(22) Filed: Sep. 20, 2016

(30) Foreign Application Priority Data
Mar. 2, 2016 (KR) 10-2016-0025319

(51) Int. Cl. F01P 7/14; F01P 5/10; F02F 1/00; F01P 3/02; F02F 1/40; F02F 1/14

(52) U.S. Cl. CPC F01P 7/14; F02F 1/40; F02F 1/14; F02F 1/004; F01P 3/02; F01P 5/10; F01P 2007/146; F01P 11/08

(57) ABSTRACT

An engine having a water jacket may include a cylinder block where cylinder liners in which pistons are disposed are arranged in a length direction, a first water jacket being provided to surround the cylinder liners, and a second water jacket provided in the length direction at an exhaust side, separately from the first water jacket, and a cylinder head disposed above the cylinder block, and including a head water jacket provided therein along a length direction thereof, wherein an exhaust side of the head water jacket receives coolant from the second water jacket through connection paths.

### CROSS-REFERENCE TO RELATED APPLICATION

The present application claims priority to Korean Patent Application No. 10-2016-0025319, filed Mar. 2, 2016, the entire contents of which is incorporated herein for all purposes by this reference.

### BACKGROUND OF THE INVENTION

Field of the Invention

The present invention relates to an engine having a structure in which coolants flowing to a head water jacket formed in a cylinder head and a block water jacket formed in a cylinder block are respectively controlled, and the head water jacket forms a crossflow flowing to an intake side from an exhaust side.

Description of Related Art

In general, in a water-cooled engine, a coolant is transferred under pressure to a water jacket in a cylinder block and to a water jacket in a cylinder head from a water pump to cool an engine.

The water pump is provided in the cylinder block, and the coolant transferred under pressure from the water pump is supplied to the water jacket in the cylinder block to introduce the coolant to the water jacket in the cylinder head from the water jacket in the cylinder block.

In addition, the cylinder head may have a high temperature because combustion chambers are formed therein, and particularly, circulation of combustion gas increases the temperature at the peripheral area of an exhaust port. Thus, a coolant path is formed at the peripheral area of each exhaust portion of the cylinder head from a water jacket of the cylinder block to enhance cooling performance.

Recently, a structure has been introduced in which a water jacket of a cylinder head and a water jacket of a cylinder block are respectively separated as a head water jacket and a block water jacket, and in which coolant supplied to each jacket is individually controlled to thereby improve cooling efficiency of the coolant, and since temperatures are respectively controlled, fuel consumption is reduced.

Also, a structure in which a crossflow structure is formed and thus the coolant flowing to the head water jacket formed in the cylinder head flows to an intake side from an exhaust side to more aggressively cool a high temperature portion of an exhaust port side (i.e., the exhaust side), and coolant flow to the block water jacket formed in the cylinder block is blocked in a low temperature state to reduce fuel consumption and improve cooling efficiency, has been introduced.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine in which coolant flowing to a head water jacket and coolant flowing to a block water jacket are respectively controlled and the coolant flowing through the head water jacket performs a crossflow to an intake side from an exhaust side to thereby reduce fuel consumption and improve cooling efficiency.

According to various aspects of the present invention, an engine having a water jacket may include a cylinder block where cylinder liners in which pistons are disposed are arranged in a length direction, a first water jacket being provided to surround the cylinder liners, and a second water jacket provided in the length direction at an exhaust side, separately from the first water jacket, and a cylinder head disposed above the cylinder block, and including a head water jacket provided therein along a length direction thereof, in which an exhaust side of the head water jacket may receive coolant from the second water jacket through connection paths.

A first inlet through which coolant is supplied to a first end of the first water jacket and a second inlet through which coolant is supplied to a first end of the second water jacket may be provided with reference to an alignment direction of the cylinder liners, and a first outlet and a second outlet may be respectively provided at second ends of the first water jacket and the second water jacket.

The second water jacket may be gradually decreased in depth in a direction from the first end where the second inlet is formed to the second end.

The first and second inlets may be formed in the first ends of the first and second water jackets receive coolant from a water pump, the first and second outlets formed in the second ends of the first and second water jackets may be connected to a water control valve, and the water control valve may control coolants supplied to at least one selected from the group including an oil cooler, a radiator, an exhaust gas recirculation (EGR) cooler, and a heater.

The connection paths may be disposed at a predetermined interval along a length direction of the second water jacket.

The connection paths may be disposed at positions corresponding to the cylinder liners.

The coolant supplied to the head water jacket through the connection paths in the second water jacket may flow along a width direction to the intake side from the exhaust side of the cylinder head to form a crossflow, and then the coolant may flow to the second outlet provided in the second end of the second water jacket.

The connection paths may include first, second, third, and fourth connection paths, the first, second, third, and fourth connection paths respectively supplying the coolant to exhaust sides of first, second, third, and fourth combustion chambers.

The engine may further include a water pump pumping the coolant to the first inlet and the second inlet; and a water control valve receiving the coolants respectively discharged from the first outlet and the second outlet, controlling the coolant discharged from each of the first outlet and the second outlet, performing separation cooling of the cylinder head and the cylinder block, and distributing the supplied coolant to at least one selected from the group including an oil cooler, a radiator, a heater, and an exhaust gas recirculation (EGR) cooler.

According to various aspects of the present invention, an engine having a water jacket may include a cylinder block in which cylinder liners forming combustion chambers are arranged along a length direction thereof, a first water jacket being provided to surround a peripheral area of the cylinder liners, a second water jacket being disposed at a distance from the first water jacket along the length direction at an exhaust side, first and second inlets respectively connected with the first and second water jackets provided at first ends of the first and second water jackets, and a first outlet provided at a second end of the first water jacket, a cylinder head provided above the cylinder block, and in which a head water jacket is provided, an exhaust side of the head water jacket being connected with the second water jacket through connection paths, and a second outlet provided in a second end of the second water jacket, a water pump supplying coolant to the first and second inlets by pumping the coolant, and a water control valve controlling coolants respectively discharged from the first and second outlets, in which the connection paths connecting the second water jacket and the head water jacket may be disposed apart a predetermined interval in a direction where the cylinder liners are arranged.

The coolant supplied to the head water jacket from the second water jacket through the connection paths may form a crossflow by flowing along a width direction from an exhaust side to an intake side of the cylinder head, and then may flows to the second outlet disposed in the second end of the second water jacket.

According to various embodiments of the present invention, the first water jacket is provided at the peripheral area of the cylinder liners disposed in the cylinder block, the second water jacket is separated from the first water jacket and disposed in the length direction of the cylinder block in the exhaust side of the cylinder block, and coolants are distributed through the connection paths formed at predetermined locations to the head water jacket formed in the cylinder in the second water jacket.

Thus, the coolant supplied to the head water jacket from the second water jacket flows to the intake side from the exhaust side of the head water jacket such that a crossflow is formed and then the coolant circulates to the water control valve through the second outlet formed in the other end of the head water jacket, and the coolant supplied to the first water jacket cools the peripheral area of the cylinder liners. The coolant flowing to the first water jacket and the coolant flowing to the second water jacket are respectively controlled at the outlet sides and accordingly the coolant of the cylinder head and the coolant of the cylinder block are separated and effectively controlled.

Further, one end of the second water jacket has the first depth d1 and the other end has the second depth d2, and the first depth d1 is deeper than the second depth d2. Thus, the coolant can be uniformly supplied to the head water jacket from the second water jacket, and the coolant flows in a width direction of the engine in the head water jacket to thereby improve crossflow efficiency.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic top plan view of an engine having a water jacket related to the present invention.

FIG. 2 is a schematic perspective view of an engine having a water jacket according to various embodiments of the present invention.

FIG. 3 is a schematic perspective view of the water jacket in the engine according to various embodiments of the present invention.

FIG. 4 is a schematic top plan view of the engine having the water jacket according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

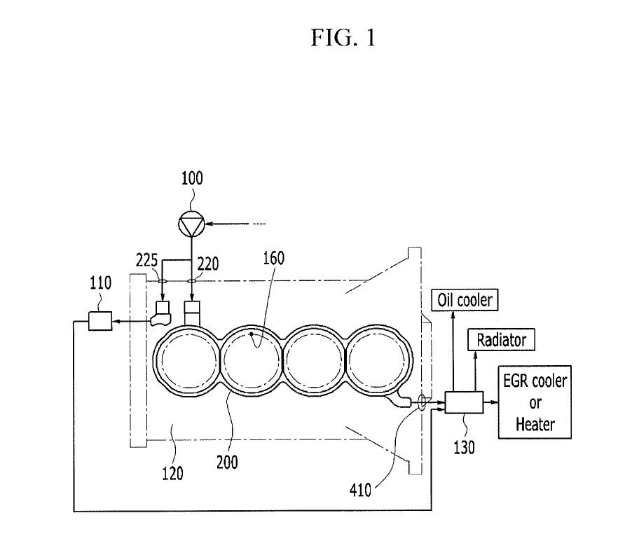

FIG. 1 is a schematic top plan view of an engine having a water jacket related to the present invention.

Referring to FIG. 1, an engine includes a water pump 100, a cylinder head 110, a cylinder block 120, cylinder liners 160, a first inlet 220, a second inlet 225, a first water jacket 200, and a water control valve 130.

In the cylinder block 120, the cylinder liners 160 are arranged along a length direction of the engine. An interior circumference of the cylinder liner 160 contacts a piston, an additional cylinder liner may be disposed therein, and the cylinder liner 160 may be made of the same material as that of the cylinder block 120. Here, the cylinder liner, the cylinder head, and the piston form a combustion chamber.

The first water jacket 200 is formed along the peripheral area of the cylinder liner 160, the first inlet 220 is formed at one end of the first water jacket 200, and a first outlet 410 is formed at the other end of the first water jacket 200.

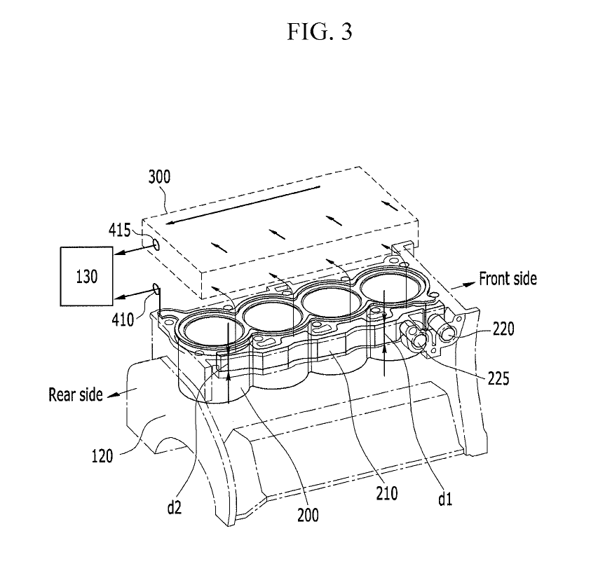

In the cylinder block 120, the second inlet 225 is formed adjacent to the first inlet 220. The second inlet 225 is connected to a head water jacket 300 (refer to FIG. 3) of the cylinder head 110 disposed in an upper portion of the cylinder block 120. The coolant pumped by the water pump 100 is supplied to the first inlet 220 and the second inlet 225, and the coolant supplied to the first inlet 220 is circulated to the water control valve 130 through the first water jacket 200 and the first outlet 410.

In addition, the coolant supplied to the second inlet 225 is circulated to the water control valve 130 through the head water jacket 300 of the cylinder head 110. The water control valve 130 may control the coolants respectively flowing to the first water jacket 200 and the head water jacket 300.

In addition, the water control valve 130 may distribute the coolant supplied from the cylinder head 110 and the cylinder block 120 to an oil cooler, a radiator, an exhaust gas recirculation (EGR) cooler, and a heater, and may control the distributed coolants, respectively.

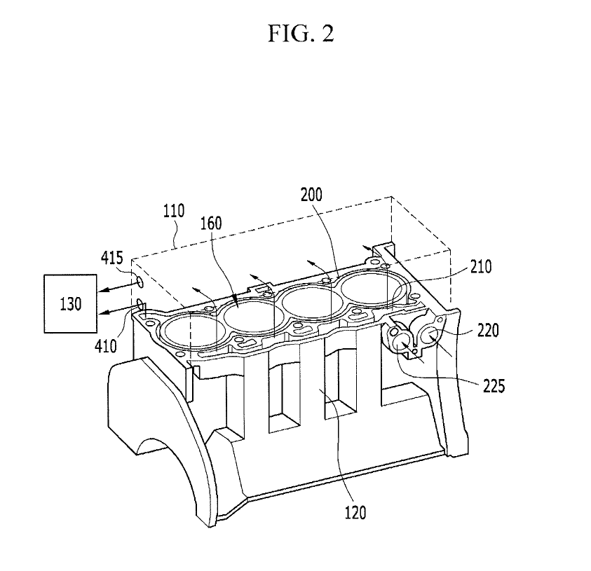

FIG. 2 is a schematic perspective view of an engine including the water jacket according to the exemplary embodiment of the present invention, and FIG. 3 is a schematic perspective view of the water jacket in the engine according to various embodiments of the present invention.

Referring to FIG. 2 and FIG. 3, the cylinder head 110 is disposed above the cylinder block 120, and the first water jacket 200 and the second water jacket 210 are formed in the cylinder block 120. The first inlet 220 and the second inlet 225 are formed to be adjacent to each other in one side of the cylinder block 120, the coolant having passed through the first inlet 220 is supplied to the first water jacket 200, and the coolant passed through the second inlet 225 is supplied to the second water jacket 210.

The first water jacket 200 is provided at the peripheral area of the cylinder liner 160 that is disposed in the cylinder block 120. The second water jacket 210 is provided at a distance from the first water jacket 200. The second water jacket 210 is provided along a length direction of the cylinder block 120 at an exhaust side of the cylinder block 120.

The coolant pumped to the first inlet 220 is supplied to one end of the first water jacket 200 and then circulates to the water control valve 130 through the first outlet 410 formed at the other end thereof, and the coolant pumped to the second inlet 225 is supplied to one end of the second water jacket 210 and then flows in the length direction of the cylinder block 210 along the second water jacket 210.

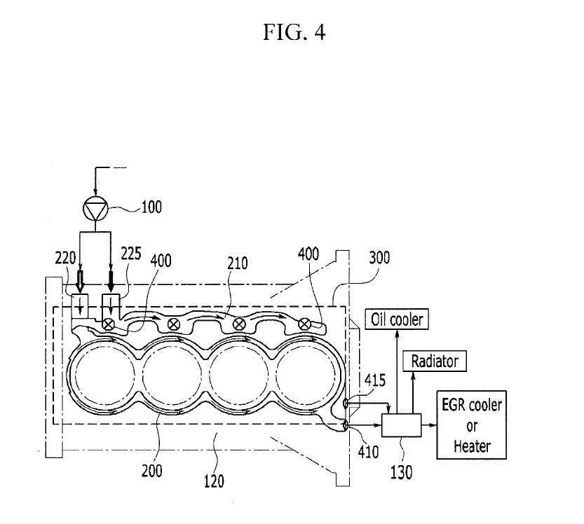

In addition, the coolant is distributed through connection paths 400 formed at predetermined locations in the head water jacket 300 of the cylinder head 110 in the second water jacket 210 (refer to FIG. 4).

The coolant supplied to the head water jacket 300 from the second water jacket 210 flows to the inlet side from the exhaust side of the head water jacket 300 such that a crossflow is formed, and then the coolant circulates to the water control valve 130 through a second outlet 415 formed at the other end of the second water jacket 210.

Referring to FIG. 3, one end of the second water jacket 210 formed in the cylinder block 120 is connected with the second inlet 225. In addition, the second water jacket 210 extends from one end to the other end thereof, and has depths d1 and d2 along the extension direction. Here, the depths d1 and d2 are different from each other. That is, one end of the second water jacket 210 has a first depth d1 and the other end has a second depth d2, and the first depth d1 is greater than the second depth d2.

The coolant is passed through the second inlet 225 and then supplied to the second water jacket 210, and one end of the second water jacket 210 is a portion through which the coolant is supplied from the water pump 100 with a comparatively fast speed. However, the speed of the coolant is decreased due to resistance in the second water jacket 210 as the coolant flows to the other end from the one end. When the second water jacket 210 has a uniform depth, the amount of coolant supplied to the cylinder head 110 through the respective connection paths 400 may be different. Thus, according to the various embodiments of the present invention, a portion where the coolant flows faster has a comparatively deeper depth to increase a cross-section thereof, thereby decreasing the flowing speed of the coolant, and a portion where the coolant flows slower has a comparatively shallow depth to decrease a cross-section thereof, thereby increasing the flowing speed of the coolant.

Accordingly, the coolant uniformly flows to the head water jacket 300 from the second water jacket 210, and the coolant flows in a width direction of the engine in the head water jacket 300 such that efficiency of the crossflow can be improved.

In FIG. 3 of the various embodiments of the present invention, a front side may denote one end and a rear side may denote the other end, and terms indicating directions such as the front side and the rear side are provided for description of the various embodiments of the present invention, and accordingly, may be changed to other terms depending on the various embodiments.

FIG. 4 is a schematic top plan view of the engine having the water jacket according to various embodiments of the present invention.

Referring to FIG. 4, the connection paths 400 supplying the coolant to the head water jacket 300 are formed in the second water jacket 210. The connection paths 400 are formed respectively corresponding to combustion chambers at locations corresponding to the cylinder liners 160, and are disposed at a regular interval from each other along the length direction of the second water jacket 210.

Thus, the second water jacket 210 uniformly supplies coolant to the head water jacket 300 through the connection paths 400, and the coolant supplied to the exhaust side of the head water jacket 300 from the second water jacket 210 flows to the intake side such that a crossflow is formed.

As shown in FIG. 3, the second inlet 225 receiving the coolant is formed at one end of the second water jacket 210. In addition, since one end of the second water jacket 210 has the first depth d1 and the depth of the second water jacket 210 is decreased toward the other end thereof such that the other end has the second depth d2, which is shallower than the first depth d1, the coolant can be uniformly supplied to the exhaust side of the head water jacket 300.

In various embodiments of the present invention, referring to FIG. 4, the connection paths 400 include first, second, third, and fourth connection paths arranged along a length direction, and the first, second, third, and fourth connection paths respectively supply the coolant to exhaust sides of first, second, third, and fourth combustion chambers such that the entire cooling efficiency of the cylinder head 110 may be improved and the crossflow of the coolant flowing to the intake side from the exhaust side can be effectively implemented.

That is, the first water jacket 200 cools only the cylinder block 120 and the second water jacket 210 supplies the coolant to the cylinder head 110 from the cylinder block 120 such that the efficiency of the crossflow can be optimized. In this case, the first water jacket 200 separately cools only the cylinder block 120, and the first to fourth connection paths are connected to center portions of the respective cylinders along the length direction of the second water jacket 210 such that the coolant can be distributed to the respective cylinders.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine having a water jacket, comprising:
a cylinder block where cylinder liners in which pistons are disposed are arranged in a length direction, a first water jacket being provided to surround the cylinder liners, and a second water jacket provided in the length direction at an exhaust side, separately from the first water jacket; and
a cylinder head disposed above the cylinder block, and including a head water jacket provided therein along a length direction thereof, wherein an exhaust side of the head water jacket receives coolant from the second water jacket through connection paths.

2. The engine having the water jacket of claim 1, wherein a first inlet through which coolant is supplied to a first end of the first water jacket and a second inlet through which coolant is supplied to a first end of the second water jacket are provided with reference to an alignment direction of the cylinder liners, and a first outlet and a second outlet are respectively provided at second ends of the first water jacket and the second water jacket.

3. The engine having the water jacket of claim 2, wherein the second water jacket is gradually decreased in depth in a direction from the first end where the second inlet is formed at the second end.

4. The engine having the water jacket of claim 2, wherein
the first and second inlets formed in the first ends of the first and second water jackets receive coolant from a water pump;
the first and second outlets formed in the second ends of the first and second water jackets are connected to a water control valve; and
the water control valve controls coolants supplied to at least one selected from the group including an oil cooler, a radiator, an exhaust gas recirculation (EGR) cooler, and a heater.

5. The engine having the water jacket of claim 2, wherein the connection paths are disposed at a predetermined interval along a length direction of the second water jacket.

6. The engine having the water jacket of claim 2, wherein the connection paths are disposed at positions corresponding to the cylinder liners.

7. The engine having the water jacket of claim 5, wherein the coolant supplied to the head water jacket through the connection paths in the second water jacket flows along a width direction to the intake side from the exhaust side of the cylinder head to form a crossflow, and then the coolant flows to the second outlet provided in the second end of the second water jacket.

8. The engine having the water jacket of claim 5, wherein the connection paths comprise first, second, third, and fourth connection paths, the first, second, third, and fourth connection paths respectively supplying the coolant to exhaust sides of first, second, third, and fourth combustion chambers.

9. The engine having the water jacket of claim 5, further comprising:
a water pump pumping the coolant to the first inlet and the second inlet; and
a water control valve receiving the coolants respectively discharged from the first outlet and the second outlet, controlling the coolant discharged from each of the first outlet and the second outlet, performing separation cooling of the cylinder head and the cylinder block, and distributing the supplied coolant to at least one selected from the group including an oil cooler, a radiator, a heater, and an exhaust gas recirculation (EGR) cooler.

10. An engine having a water jacket, comprising:
a cylinder block in which cylinder liners forming combustion chambers are arranged along a length direction thereof, a first water jacket being provided to surround a peripheral area of the cylinder liners, a second water jacket being disposed at a distance from the first water jacket along the length direction at an exhaust side, first and second inlets respectively connected with the first and second water jackets provided at first ends of the first and second water jackets, and a first outlet provided at a second end of the first water jacket;
a cylinder head provided above the cylinder block, and in which a head water jacket is provided, an exhaust side of the head water jacket being connected with the second water jacket through connection paths, and a second outlet provided in a second end of the second water jacket;
a water pump supplying coolant to the first and second inlets by pumping the coolant; and
a water control valve controlling coolants respectively discharged from the first and second outlets,
wherein the connection paths connecting the second water jacket and the head water jacket are disposed apart a predetermined interval in a direction where the cylinder liners are arranged.

11. The engine having the water jacket of claim 10, wherein the second water jacket is gradually decreased in depth in a direction from the first end where the second inlet is provided to the second end.

12. The engine having the water jacket of claim 10, wherein the coolant supplied to the head water jacket from the second water jacket through the connection paths forms a crossflow by flowing along a width direction from an exhaust side to an intake side of the cylinder head, and then flows to the second outlet disposed in the second end of the second water jacket.
